(19) United States
(12) Patent Application Publication
(10) Pub. No.: US 2016/0343457 A1
(43) Pub. Date: Nov. 24, 2016

(54) Thermonuclear Dynamo Inside Ultracentrifuge with Supersonic Plasma Flow Stabilization

(71) Applicant: Friedwardt M. Winterberg, Reno, NV (US)

(72) Inventor: Friedwardt M. Winterberg, Reno, NV (US)

(21) Appl. No.: 14/719,952

(22) Filed: May 22, 2015

(51) Int. Cl. G21B 1/05

(52) U.S. Cl. CPC G21B 1/05

(57) ABSTRACT

The proposed novel nuclear fusion concept is unique because it makes use of the self-exciting magnetohydrodynamic dynamo principle for its steady state operation, with the dynamo driven by the heat released from thermonuclear reactions in the fusion plasma. But it also has the potential to reach much larger magnetic fields for confinement and particle number densities than are otherwise possible. This leaves open the question how to remove the heat from the centrifuge, even though this problem exists for the DT reaction only for the 20% of the fusion energy released in the centrifuge as charged particles, not for the 80% of the energy going into the kinetic energy of the neutrons which can be slowed down outside the centrifuge over a much larger distance. One possible solution is to place the centrifuge in a supersonic potential gas vortex, for example a vortex of helium gas, with the high velocity vortex core touching the outer surface of the centrifuge at a velocity of ˜1 km/s, respectively the same tangential velocity of the ultracentrifuge.

### BACKGROUND OF INVENTION

There are two main approaches for the controlled release of energy by thermonuclear fusion: 1. by magnetic, and 2. by inertial confinement. Both are confronted with the problem of their large dimensions. Here I propose a third approach. It makes use of a peculiar property of the general theory of relativity, which is that large negative masses appear in accelerated reference systems, particularly in rotating reference systems. In addition, this approach utilizes a discovery made by the inventor in 1985 [1] (Beitr. Plasmaphy. 25 (1985) 2, 117-123), to stabilize a linear pinch discharge with a supersonic flow and the thermomagnetic Nernst effect, by launching with supersonic velocities a needle-like projectile through the pinch discharge channel, where the magnetic field generated by the thermomagnetic Nernst effect magnetically insulates the pinch discharge plasma from the projectile. A similar proposal was made by A. B. Hassam and Yi-Min Huang [2] (Physical Review Letters 91, 195002-1 (2003)), who had proposed to launch a supersonic DT (deuterium-tritium) jet into a magnetized large aspect ratio magnetized torus, where the magnetic field generated by the thermomagnetic Nernst effect repels the DT jet from the inner surface of the torus.

The novelty of the invention is the replacement of the needle moving at supersonic velocities with the supersonic rotational velocities of the ultracentrifuge, and the large aspect ratio torus, with the small aspect ratio ultracentrifuge, which according to the general theory of relativity, has the large negative mass density of the Coriolis force field.

### BRIEF SUMMARY OF THE INVENTION

The invention is a novel way for the release of energy by nuclear fusion making use of the fact that according to the general theory of relativity, large negative mass densities, comparable to the large positive mass densities of neutron stars, can be realized in the reference frame of an ultracentrifuge by the negative mass density of the Coriolis force field. While the plasma in a neutron star is stably confined by the attractive Newtonian force of gravity, it is here stably confined by the repulsive force of negative masses towards the inner wall of the ultricentrifuge and by the magnetic field separating it from the inner wall, generated there by the thermomagnetic Nernst effect in the supersonic flow separating the hot plasma from the cold inner wall. No plasma instabilities can arise, either from the repulsive force of the negative masses or from the plasma flow not only because it is supersonic, but also because of its high densities it is collision dominated. Furthermore, since the proposed novel concept works by the principle of a self-exciting dynamo, it greatly reduces the energy input requirement to keep the plasma at its fusion ignition temperature. The proposed concept is a self-exciting magnetohydrodynamic dynamo driven by the heat released in the thermonuclear reactions, it is a configuration coming close to a thermonuclear fusion-driven star.

### DETAILED DESCRIPTION OF INVENTION

The release of energy by thermonuclear fusion requires large magnetic fields for the confinement of a dense plasma, and furthermore to keep the plasma in a stable equilibrium. These problems do not exist for a star where the confinement is by the gravitational field of the star. While it is not possible to make a laboratory-size star, it is possible to reach a centrifugal field comparable to the gravitational field of a very dense star, with a density of the same order of magnitude as the density of a neutron star. It is the general theory of relativity which makes this possible. In this theory the gravitational energy cannot be localized, but is described by Einstein's pseudo tensor t^{ik} [3], where the energy and momentum are expressed by a sum of products made up of Christoffel symbols ┌ₖₗⁱ, with these symbols standing for the forces. In a non-inertial reference frame these forces represented by the Christoffel symbols are generally different from zero even in the absence of gravitational-force-producing masses. As it was shown by Hund [4], for non-relativistic velocities these forces can be obtained by Newtonian mechanics.

In a rotating reference frame, as in a centrifuge, the equation of motion for a test particle is given by

$$m \frac{d v}{d t} = mF + m \frac{v}{c} \times C \qquad ( 1 )$$

where

F=ω²r (2)

is the centrifugal force, and

C=−2cω (3)

the Coriolis force, and where ω is the angular velocity vector of rotation. If F is a gravitational acceleration produced by the mass distribution ρ for the source of Newton's law of gravity one has:

divF=−4πGρ (4)

where G is Newton's constant. A centrifugal acceleration is also not free of sources, because for (2) one has

divF=2ω² (5)

and hence the negative mass density

$$ρ = - \frac{{ω}^{2}}{2 π G} \qquad ( 6 )$$

This mass is not fictitious and can be felt as the repulsive force in a merry-go-round. For ω=0.6 sec (an example given by Hund) one has ρ=−10⁶ g/cm³, comparable to the mass density of a white dwarf star.

The mass density (6) represents a physical reality as the mass density of the electric field E:

$${ρ}_{e} = \frac{{E}^{2}}{8 π {c}^{2}} \qquad ( 7 )$$

While the mass density (7) is positive because the equal sign electric charges repel each other, the mass density of a gravitational field g where equal sign masses attract each other is negative is

$$ρ = \frac{- {g}^{2}}{8 π G} \qquad ( 8 )$$

The mass density of the Coriolis field (3)

$$ρ = - \frac{{C}^{2}}{8 π {Gc}^{2}} = - \frac{{ω}^{2}}{2 π G} \qquad ( 9 )$$

is equal to the mass density given by (6), which means that the centrifugal force is caused by the negative mass density of the Coriolis force field. By comparison, the negative mass density of the centrifugal force field (2) is smaller by the order v²/c².

Let us compare the negative mass density inside an ultracentrifuge with the positive mass density, ρ_{N}≃10¹⁴ g/cm³, of a neutron star. With an ultracentrifuge one can reach an acceleration α of the order α≃2×10⁹ cm/s² . With ω=\sqrt{α/R}, where R is the radius of the centrifuge , and assuming that R=30 cm, one finds that ω≃2.6×10³s⁻¹, hence ρ≃−10¹⁴ g/cm³, of the same order of magnitude but of the opposite sign.

A self-exciting magnetohydrodynamic dynamo requires: 1. Fusion energy input to drive the DT plasma; 2. A magnetic Reynolds number larger than one; 3. A rapid rotation provided by the Coriolis force inside the centrifuge; 4. A magnetic seed field to be stretched and amplified by the plasma flow.

The energy input is provided by the heat released in the burning DT plasma.

A magnetohydrodynamic dynamo is ruled by the equation (generalized Ohm's law in cgs units)

$$\frac{\partial B}{\partial t} = \frac{{c}^{2}}{4 πσ} {∇}^{2} B + curlv \times B \qquad ( 10 )$$

where σ is the electrical conductivity, the Euler equation of motion with the magnetic body force (1/c) j×B where j is the electric current density, (neglecting viscous forces) given by

$$\frac{\partial v}{\partial t} = - \frac{1}{ρ} ∇ p - \frac{1}{2} ∇ {v}^{2} + v \times curlv + \frac{1}{ρ c} j \times B \qquad ( 11 )$$

in addition to the equation of continuity (mass conservation) and energy. For a uniform rotation of the ultracentrifuge, one can write

v=ω×r (12)

where ω=(½)curlv with (4π/c)j=curlB, one thus has for (11)

$$\frac{\partial v}{\partial t} = - \frac{1}{ρ} ∇ p - {ω}^{2} r - 2 ω \times v - \frac{1}{4 πρ} B \times curlB \qquad ( 13 )$$

The dynamo theory was pioneered by Walter Elsasser [5], but only recently has it become possible to obtain numerical solutions with the advent of supercomputers. Because of these difficulties it was already proposed by the author back in 1963, to obtain solutions experimentally by simulating such dynamos in liquid metals (such as liquid sodium), brought into rapid rotation and with a propeller to simulate the thermal convection [6]. This idea has been more recently adopted by a number of research groups all over the world [7], with the group in Maryland acknowledging the origin of this idea[8].

Even without solving these equations, some general conclusions can already be drawn:

1. For the buildup of the magnetic field in eq.(10) one must have ∂B/∂t >0, which requires that the second term on the r.h.s of (10) is larger than the first term, or that the magnetic Reynolds number

$$Rem = \frac{4 πσ Rv}{{c}^{2}} > 1 \qquad ( 14 )$$

where R is the radius of the ultracentrifuge and v is the plasma velocity. Instead of (14) one can also write

$$\begin{matrix}v > \frac{{c}^{2}}{4 πσ R} \\ or & ( 15 ) \\ σ > \frac{{c}^{2}}{4 π {Rv}_{0}} & ( 16 )\end{matrix}$$

Setting vₒ=10⁵cm/s for the tangential velocity of the ultracentrifuge, equal to the initial velocity of the plasma touching its wall, and for its radius R ≃30 cm, one finds that σ≳2.5×10^{—}s⁻¹. On the other hand, the conductivity of a fully ionized plasma for T ≳10⁵K is

σ≃10⁷T^{3/2}s⁻¹ (17)

which means that for T ≳10⁵K, one has σ≳3×10¹⁴s⁻¹, or that for T ≧10⁵K, σ is larger than (16).

2. It is therefore proposed to inject a DT jet into the ultracentrifuge, for example with a velocity of ˜10⁶cm/s, which upon impact on the wall of the centrifuge would lead to a DT plasma with a temperature of the order of ˜10⁵K needed to start the dynamo.

3. With the start of the dynamo action the plasma is heated to high temperatures until the ignition temperature of a DT plasma at T ≃10⁸K is reached, where the electrical conductivity is of the order σ˜10¹⁹s⁻¹.

With the plasma accelerated by the magnetic forces to a velocity of the order v˜10⁸cm/s, the magnetic Reynolds number (for R=30 cm) is of the order 10⁸, whereby eq.(10) can be approximated extremely well by

$$\frac{\partial B}{\partial t} = curlv \times B \qquad ( 18 )$$

The magnetohydrodynamic instabilities arise from the last term on the r.h.s. of (13), at the moment when the magnetic forces overwhelm the fluid stagnation pressure or when B²/8π≧(½)ρv². For (½)ρv²>>B²/8π, the magnetic lines of force align themselves with the streamlines of the fluid flow. Then, if likewise the electric current flow lines j align themselves with ω, one has j⊥B, and ω⊥v. With ω=(½)curlv and j=(c/4π)curlB one can write for (½)ρv²>>B²/8π

$$\vert v \times curlv \vert ≫ \vert \frac{B \times curlB}{4 πρ} \vert \qquad ( 19 )$$

or that

v>v_{A} (20)

where

$${v}_{A} = \frac{B}{\sqrt{4 πρ}} \qquad ( 21 )$$

is the Alfvén velocity. Initially, one may set in equation (12) for |ω| the value for the spinning ultracentrifuge, but with the build-up of the magnetic by (18), B will eventually reach the value B=\sqrt{4πρν}, where ν=ν_{A}. In approaching this magnetic field strength, the magnetic pressure forces begin to distort the fluid flow which becomes unstable. In a plasma this leads to the formation of unstable pinch current discharges, where p=B²/8π. For a hydrogen plasma of temperature T and particle number density n this leads to the Bennett equation (k Boltzmann constant)

B=\sqrt{16πnkT} (22)

The pinch instability can be seen as the breakdown of the plasma into electric current filaments, determined by the B×curlB term, whereas the v×curlv term is responsible for the breakdown of the plasma in vortex filaments. But while the breakdown into current filaments is unstable, the opposite is true for the breakdown into vortex filaments. This can be seen as follows: Outside a linear pinch discharge one has curlB=0, and outside a linear vortex filament one has curlv=0. Because of curlB=0, the magnetic field strength gets larger with a decreasing distance from the center of curvature of magnetic field lines of force. For curlv=0, the same is true for the velocity of a vortex line. But whereas in the pinch discharge a larger magnetic field means a larger magnetic pressure, a larger fluid velocity means a smaller pressure by virtue of Bernoulli's theorem. Therefore, whereas a pinch column is unstable with regard to its bending, the opposite is true for a line vortex. This suggests that a pinch column places itself inside vortex tube.

What is true for the m=0 kink pinch instability is also true for the m=0 sausage instability by the conservation of circulation

Z=∫v.dr=const. (23)

And because of the centrifugal force the vortex also stabilizes the plasma against the Rayleigh-Taylor instability.

In the ultracentrifuge the self-exciting magnetohydrodynamic dynamo is driven by the heat released in the thermonuclear reactions, resulting in the thermal expansion of the plasma and the doing of work against the confining magnetic field, whereby the field is amplified, closing the self-exciting dynamo cycle. This leads to large plasma velocities magnifying the magnetic field up to the value given by (22), where the Alfvén velocity and plasma velocity are about equal to the thermal proton velocity v=\sqrt{kT/M}. For T=10⁸K one has ν=10⁸cm/s. For the pressure of p=10¹⁰dyn/cm² , at the wall of the centrifuge, the magnetic field is B=500 kG, and the particle number density n≃10¹⁸/cm³, orders of magnitude larger as in other magnetic confinement concepts.

The final plasma configuration (shown in FIG. 2) is a rotating torus, as in the proposal by Hassam and Yi-Min Huang [2], but with a small aspect ratio.

In the invention the plasma is radially confined in between the convex centrifugal force in the ultracentrifuge, and the concave centripetal magnetic force set up by the thermomagnetic current at the cold wall inside the centrifuge. According to Einstein's equivalence principle, the ions and electrons are affected by the centrifugal force in the same way as by the gravitational force in a star, having a stable configuration, but an instability may still arise in the thin boundary layer carrying the thermomagnetic current near the wall of the centrifuge. As Teller has pointed out in a private communication [9], the instabilities of magnetic confinement configurations are likely to be absent in collision-dominated plasmas, or in plasmas where the mean free path λ is smaller than the linear dimension L of the magnetic confinement configuration. At the temperature T [K], and particle number density n [1/cm³], the mean free path is given by [10]

λ≃10⁴T²/n² (24)

For the typical temperature of a burning DT plasma one has T≃10⁸K. With a particle number density in the ultracentrifuge at this temperature n ≃10¹⁸/cm³, the mean free path is λ˜10²cm. Setting L=2πR for the dimension, where R=30 cm, one has L=2×10²cm, and one finds that λ≦L, which means that the plasma is stable. Because of the T² dependence of λ, stability is enhanced for plasma temperatures below the ignition below T ˜10⁸K.

In summary, because the plasma flow is supersonic and the plasma density very high, the configuration should be stable.

### BRIEF DESCRIPTION OF THE DRAWINGS

A sketch of the proposed fusion engine is shown in FIG. 1, in the r-z (FIG. 1.a) and r-φ(FIG. 1.b) plane, with the ultracentrifuge U centered along the z-axis, between opposite poles of two magnets. The pole to the left has an opening along the z-axis for the injection of a high-velocity DT jet, as in the experiment by Hassam and Yi-Min Huang [2]. To the right is a conical opening to allow the fusion reaction products to exhaust. As shown in the r-z and r-φ cuts the DT fusion plasma is radially confined in between the centrifugal force field of the centrifuge U and the magnetic field of thermomagnetic current in the boundary layer between the hot DT plasma and the cool inner wall W of the centrifuge.

FIG. 1a is a cut in the r-z of a cylindrical polar coordinate system with the centrifuge centered along the z-axis, and FIG. 1b, a cut in the r-φ plane. In addition to the centrifuge U, FIG. 1a displays an axial magnetic field B from the poles P+ to P−. The left and right pole P+ and P− have a pipe for the left pole to inject a DT (deuterium-tritium) jet into the centrifuge, and for the right pole to exhaust the fusion products. The centrifuge U can be magnetically levitated, in full or in part, and is driven to the high rotational velocity by a rotational magnetic wave, a technique commonly used in ultracentrifuge designs.

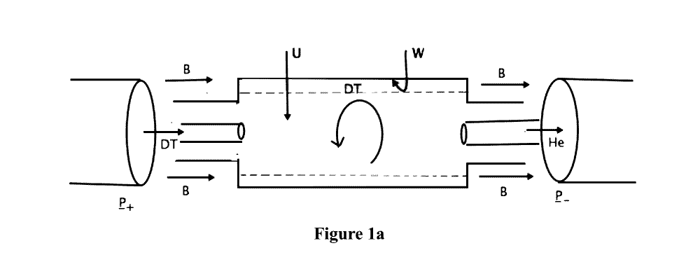

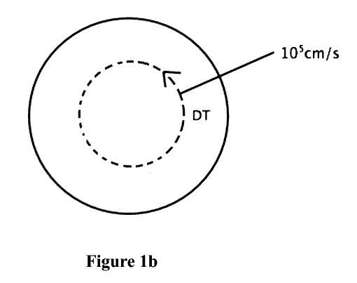

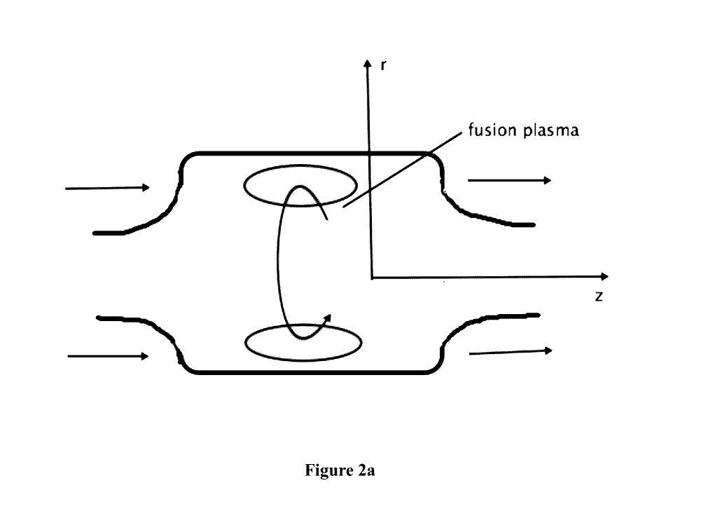

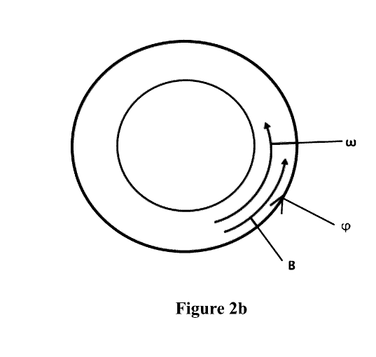

The final plasma configuration shown in FIG. 2a is a rotating torus, as in the proposal by Hassam and Yi-Min Huang [2], but with a small aspect ratio. It shows another cut in r-z and r-φ plane.

In FIG. 2b, ω is the angular velocity of the centrifuge, and B the magnetic field amplified by the magnetohydrodynamic dynamo establishing itself in the rapidly rotating plasma, with the dynamo driven by the thermonuclear reactions of the fusion plasma.

1. A plasma placed inside an ultracentrifuge for the confinement of the plasma by the repulsive centrifugal force of that centrifuge and the confining force of a strong magnetic field set up inside the centrifuge, where the magnetic field is set up in between the plasma and the inner wall of the centrifuge and is generated by the self-exciting magnetohydrodynamic dynamo of the rapidly rotating plasma.

2. The use of the proposed concept as in 1, for the controlled release of energy by nuclear fusion.

3. The use of the proposed concept under 1, for the propulsion of space craft.

4. The use of the proposed concept under 1, for the propulsion of ships, railroads, and airplanes.

5. The use of the proposed concept under 1, for the production of radioactive substances.
